(19) United States
(12) Patent Application Publication
(10) Pub. No.: US 2011/0069501 A1
(43) Pub. Date: Mar. 24, 2011

(54) LED recessed light with heat dissipation

(76) Inventors: Meng Hsieh Chou, Sinjhuang City (TW); Yen Chi Wu, Sinjhuang City (TW)

(21) Appl. No.: 12/703,762

(22) Filed: Feb. 11, 2010

(30) Foreign Application Priority Data
Sep. 18, 2009 (TW) 098217190

(51) Int. Cl. F21V 29/00

(52) U.S. Cl. 362/373

(57) ABSTRACT

An LED recessed light with heat dissipation includes a heat sink base, an LED illumination module, a sleeve and a transparent board. The heat sink base has a first surface and a second surface. The LED illumination module has a print circuit board mounted on the first surface of the heat sink base and a plurality of LED is arranged on the print circuit board. The sleeve is mounted on the first surface of the heat sink, so as to the LED illumination module is located within the sleeve. The transparent board is arranged at the sleeve for covering the LED illumination module.

### FIELD OF THE INVENTION

The present invention relates to an LED recessed light with heat dissipation, and in particular to an LED recessed light capable of increasing the heat dissipation of the LED illumination.

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED recessed light with heat dissipation capable of increasing the heat dissipation of the LED illumination.

To achieve the above-mentioned object, the present invention includes a heat sink base having a first surface and a second surface. An LED illumination module, which includes a print circuit board mounted on the first surface of the heat sink base and a plurality of LED arranged on the print circuit board. A sleeve is mounted on the first surface of the heat sink, so as to the LED illumination module is located within the sleeve. And a transparent board is arranged at the sleeve for covering the LED illumination module.

Therefore, the heat energy from the LED illumination module may be dissipated through the heat sing base.

### BRIEF DESCRIPTION OF THE DRAWINGS

FIG. 1 is an exploded view of an LED recessed light with heat dissipation of the present invention

FIG. 2 is a cross-sectional view of assembly drawing of the FIG. 1.

FIG. 3 is a second preferred embodiment of the heat sink base of LED recessed light with heat dissipation.

### DETAILED DESCRIPTION OF THE INVENTION

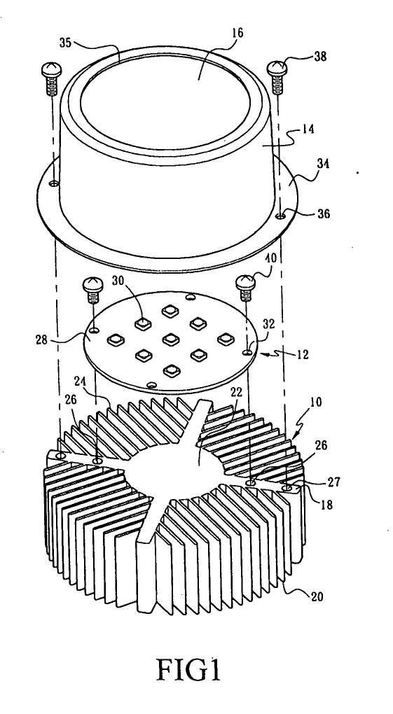

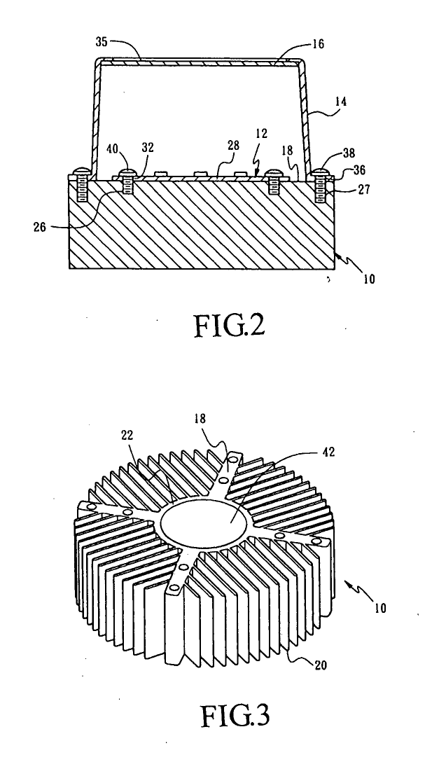

Referring to FIG. 1 and FIG. 2, an LED recessed light with heat dissipation of the present invention includes a heat sink base 10, an LED illumination module 12, a sleeve 14 and a transparent board 16.

The heat sink base 10, which is integrally having a first surface 18, a second surface 20 and a cylinder 22 formed in the central of the heat sink base 10, the first surface 18 has first fixed holes 26 and third fixed holes 27, the cylinder 22 has a plurality of heat sink sheet 24.

The LED illumination module 12, which includes a print circuit board 28 mounted on the first surface 18 of the heat sink base 10 and a plurality of LED 30 arranged on the print circuit board 28, the print circuit board 28 has second fixed holes 32 correspond to the first fixed holes 26 of the heat sink base 10, so as to the print circuit board 28 may mounted at the heat sink base 10 through the second screwed element 40.

The sleeve 14 is a hollow body, one end of the sleeve 14 is formed with a flange 34, which has forth fixed holes 36, and another end of the sleeve 14 is formed with a open 35, so that the sleeve 14 may mounted at the heat sink base 10 through a first screwed element 38, thus, the LED illumination module 12 is located within the sleeve 14.

The transparent board 16 is arranged at the open 35 of the sleeve 14 for covering the LED illumination module 12.

Please referring to FIG. 3 is a second preferred embodiment of present invention, wherein the cylinder 22 of the heat sink base 10 has a hollow penetrated the first surface 18 to the second surface 20 of the heat sink base 10, so as to the recessed light of the present invention may reduce the weight to enhance the convenient of the manufacturing.

While the present has been described by way of an example and in terms of a preferred embodiment, it is to be understood that the invention is not limited to the disclosed embodiment. To the contrary; it is intended to cover various modifications. Therefore, the scope of the appended claims should be accorded the broadest interpretation so as to encompass all such modification.

What is claimed is:

1. An LED recessed light with heat dissipation comprising:
A heat sink base having a first surface and a second surface;
An LED illumination module, which includes a print circuit board mounted on the first surface of the heat sink base and a plurality of LED arranged on the print circuit board;
A sleeve mounted on the first surface of the heat sink, so as to the LED illumination module is located within the sleeve; and
A transparent board arranged at the sleeve for covering the LED illumination module.

2. The LED recessed light with heat dissipation according to claim 1, wherein the heat sink base has a cylinder body and a plurality of heat sink sheets located at the cylinder.

3. The LED recessed light with heat dissipation according to claim 1, wherein the first surface of the heat sink is formed with a plurality first fixed holes, the print circuit board of the LED illumination module is formed with a plurality of second fixed holes correspond to the first fixed holes, so as to the print circuit board may fixed at the heat sink base through a second fixed element.

4. The LED recessed light with heat dissipation according to claim 1, wherein the first surface of the heat sink is formed with a plurality third fixed holes, the sleeve is formed with a plurality of forth fixed holes correspond to the third fixed holes, so as to the sleeve may fixed at the heat sink base through a first fixed element.

5. The LED recessed light with heat dissipation according to claim 2, wherein the cylinder body of the heat sink base has a hollow penetrated the first surface to the second of the heat sink base.

6. The LED recessed light with heat dissipation according to claim 2, wherein heat sink base is integrally.
